(19) United States
(12) Patent Application Publication
(10) Pub. No.: US 2010/0180324 A1
(43) Pub. Date: Jul. 15, 2010

(54) Method for protecting passwords using patterns

(76) Inventor: Rangan Karur, Thornhill (CA)

Correspondence Address: KARUR SRINIVASA RANGAN, 36 ABERFELDY CRESCENT, THORNHILL, ON, L3T-4C2, CA

(21) Appl. No.: 11/063,461

(22) Filed: Feb. 24, 2005

(51) Int. Cl. H04L 29/06

(52) U.S. Cl. 726/6

(57) ABSTRACT

A method, system and computer program for protecting the password by limiting the password's validity to the user's active session. The present invention provides for password to automatically change for each session and only the user will be able to construct the valid password for the session. The user provides to the authentication system, a password pattern, embedding symbols in to a string. The embedded symbols are substituted by elements of parameters. The parameter elements and the symbols that represent them are defined by the authenticating system. The parameters contain either time driven or random string of characters and digits as elements. The user builds a password using the values of the elements in the session parameters and the user's password pattern's memory hint recalled from memory. The authenticating system generates the valid password for the session using the password pattern the user has provided. If the users built password matches the authenticating system generated password, secured access is allowed otherwise access is denied.

### FEDERALLY SPONSORED RESEARCH

Not Applicable

### SEQUENCE LISTING OR PROGRAM

Not Applicable

### BACKGROUND

1. Field of Invention

This invention relates to login procedures that authenticates users through user identification and a password and then allow or deny access to secured electronic devices and services.

2. Description of Prior Art

The users of electronic services such as personal bank accounts or computers where confidential data is stored, usually provide to an authenticating system (a) an user identification or account number or machine readable card which reads the bar code containing the account number and (b) a sequence of characters known as pin code or password. The authenticating system then allows the user to access the secured resources if there is a corresponding pair of items (a) and (b) stated above, in the authenticating system's encrypted storage of authorized user identification and password. The User identification and password, here after, will be referred to as UID and PW.

The problem with such password verification method is that any other person who steals the UID & PW combination can clandestinely use it to gain access to the secured devices or services. To protect the UID & PW combination from non authorized users, the combination data can be encrypted after capture, transmitted and stored safely in an encrypted form. UID & PW data is exposed before they are encrypted.

There are many patents that teach us authentication procedures for such UID & PW combinations. As disclosed by Greene et al Patent No. U.S. Pat. No. 6,802,000 B1 Oct. 5, 2004, these require multiple challenge and response communications between the authenticating system and the user or device requesting secured access. The valid passwords need instructions from the authenticating system. My invention can be used as in a simple conventional password authentication method and does not require any instruction from the authenticating system or password list and personal character list that the user should have handy to gain access to the secured resource.

In the smart card application as disclosed by Deo, Patent number U.S. Pat. No. 5,594,227, Jan. 14, 1997, the password data is stored on the smart card. Snooping and sniffing devices mounted appropriately at the ATM location can pickup the card identity and the user's password when the card is being authorized. My invention makes the password not reusable and thus protects the smart card from unauthorized use.

There are other forms of providing very individualized identities that cannot be duplicated such as finger prints, voice pattern, iris pattern, lip movement etc. For these authentication procedures to work properly, the devices that capture the identities and the verification software methodologies have to be located at the entry points. Thus, the specialized method cannot be utilized widely such as personal computer keyboards or over the Internet. Such specialized devices are costly to implement.

In conclusion, insofar as I am aware, no authentication method has been developed which protects the UID & PW combinations when they are in the raw stage before encryption and thus prevent use of such stolen authorization codes by unauthorized persons. The personalized identity techniques e.g., finger print reader, lack the simplicity of use in that they cannot be deployed over internet. Any device that tries to incorporate personal identity feature requires major modification to include functions of the identity reader devices.

### OBJECTS AND ADVANTAGES

Accordingly, several objects and advantageous of the invention are:
A. Provide a password that changes automatically
B. Only the user can build his or her own valid password
C. The validity of the password is limited based on the password pattern.
D. Does not need any specialized devices
E. Can be used over the internet and wireless
F. exposure of the password at entry point before encryption is eliminated because the derived password strings cannot be reused and
G. The valid passwords can be built easily by authorized users and devices.

### SUMMARY OF THE INVENTION

The present invention concerns a protection mechanism for the password that provides the method to:
A. associate the User identification with the Password pattern known only to the authorized user,
B. generate the time dependent and the string of random character parameters at the time of the request for authentication,
C. enable user to derive the valid password from the user's password pattern's memory hint and the generated parameters, and submit the user identification and the derived password to the authenticating system,
D. let the authenticating system derive the password independently and compare it with the user submitted derived password and if they match, allow secured access otherwise deny secured access.

### FIGURES

FIG. 1a: Time parameter, one of a set of parameters used in deriving passwords that is based on date and time.

FIG. 1b: String parameter, one of a set of parameters used in deriving passwords that is based on random string of characters and digits.

FIG. 1c: Symbol Table, containing symbols to refer to positions in the time parameter and string parameter.

FIG. 1d: User Table, containing authorized users and their password patterns.

FIG. 1e: Location Table, containing authorized devices.

FIG. 1f: Session Table, containing login information.

FIG. 2a: Example of symbol substitution, showing between symbol and the time and string parameters.

FIG. 2b: Examples of password patterns, shows formats.

FIG. 2c: Examples of Derived Passwords, shows deriving passwords from password patters.

FIG. 3: Login Dialog Display, shows display and enterable data items.

FIG. 4a: Authentication system—setup, lists administrative operations.

FIG. 4b: Requesting system—Login initiation, process flow to initiate login session.

FIG. 4c: Requesting system—Submit credentials, process flow to get access permission from the authenticating system.

FIG. 4d: Authenticating system—Verify credentials, process flow to check credentials and issue access permission.

FIG. 5a GPS Location, one of a set of parameters used in deriving passwords that is based on GPS location.

FIG. 5b Resource Parameter, one of a set of parameters used in deriving passwords that is based on menu choices.

FIG. 5c Additions to Symbol table, containing symbols to refer to positions in the GPS & Resource tables

### DESCRIPTION OF THE PREFERRED EMBODIMENT

This invention protects passwords by use of a set of parameters that change in value when the parameters' associated events occur. A set of symbols represent the elements of the set of parameters. The symbols are embedded within a string to create a password pattern PPW. A derived password is obtained by substituting the embedded symbols with the values of the elements of the parameters at the time of requesting secured access. The set of parameters are generated by the authenticating system when the requesting system initiates a credential validation. A built password BPW is one that the user derives from the user's PPW and the values of the generated parameters. A generated password GPW is one that the authentication system derives from the user's PPW and the generated parameters. The authenticating system allows secured access when BPW and GPW are identical.

The present invention is compatible with conventional password authentication systems and allows users to use conventional password PW or the invention's PPW as desired by the user. A PPW without any embedded symbols is a conventional PW. In the authentication process, the methods for handling PPW and PW are the same.

The present invention uses a set of tables that are stored in the authentication system, a login dialog display and methods to authenticate requests for secured access.

The set of tables are:

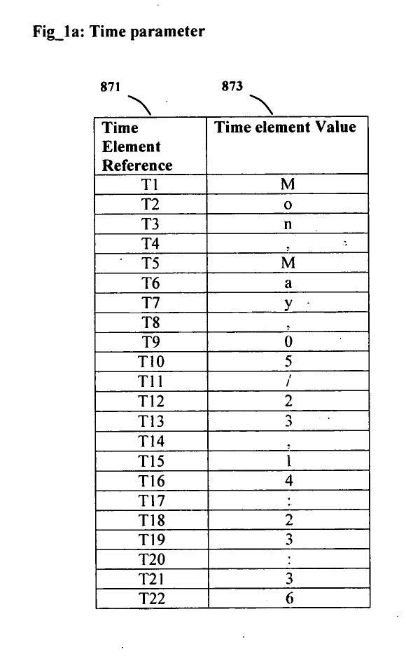

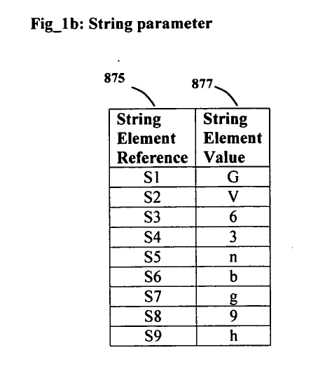

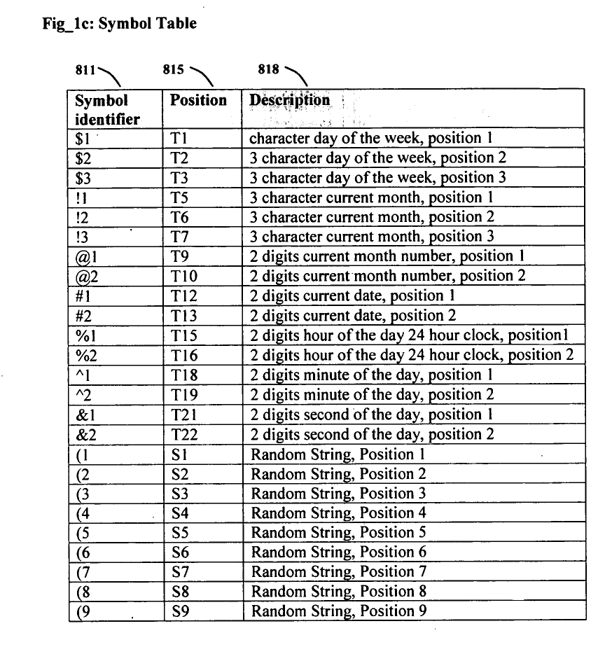

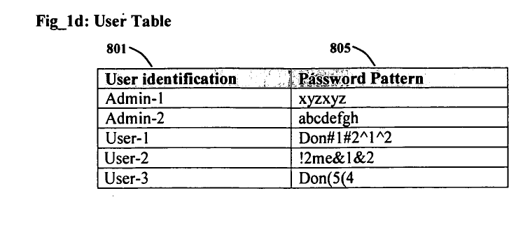

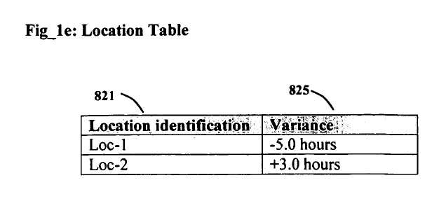

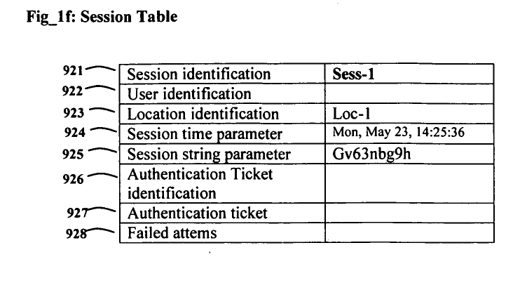

FIG. 1a Time Parameter TP stores the current value of the attributes of the event associated with the time parameter. Time parameter is one of the set of parameters that can be used to change derived passwords. Date and time is used as an example for the time parameter. Only one instance of the time parameter is stored in this table. This table contains a plurality of time element reference 871

FIG. 1b String Parameter SP stores the current value of a string of randomly generated characters and digits. String parameter is one of the set of parameters that can be used to change derived passwords. Only one instance of the string parameter is stored in this table. This table contains a plurality of string element reference 875 and the corresponding string element value 877.

FIG. 1c Symbol table stores a plurality of symbol 811, a position 815 giving the location of the element within TP or SP that the symbol 811 represents and a description 818 of the element of the parameter the symbol represents. The parameter values change with the occurrence of related event stated in 818.

Alternative embodiment of symbol table can be constructed using other symbols, parameters and associated events. Considerations in creating symbol table FIG. 1c are:
A. The values of the parameters TP and SP should change with occurrence of selected events and for each request for authentication.
B. The changing values of the parameters should be displayed to the user to help the user to build derived password.
C. The values of the parameters should consist of only alpha characters and numeric digits. Symbols are not allowed in
D. Symbols are reserved for use in PPW.
E. Authentication process and the users should be able to derive and 877

FIG. 1d User table stores a plurality of User identification 801 and their Password Pattern 805. Only authorized users of the secured resources are stored in FIG. 1d by a person responsible for the security of the resources Sec-Admin. User identification 801 contains identification code of User, Device, Account maintained by the user of the corresponding user identification 801. The symbols 811 shown in the symbol table FIG. 1c can be embedded within a string of alpha characters and numeric digits to create 805.

FIG. 1e Location Table stores, a location identification 821 and a variance 825. 825 is the difference between the value of the time parameter at the requesting location from the value at authentication system, e.g., difference between time zones of the authentication and requesting systems. The sec-admin assigns unique 821 to the requesting system device which is allowed to request secured access. The authenticating system can also assign temporary unique 821 for roaming devices.

FIG. 1f Session Table stores, a session identification 921, a session time parameter 924 and a session string parameter 925. The session identification is a unique identifier issued by the authenticating system to a secured access initiation by the requesting system. The session time parameter FIG. 1a and the session string parameter FIG. 1b are generated by authenticating system, stored in the session table and passed to the requesting system. Location identification 923, if available from the requested system is also stored. The requesting user Identification 922, authentication ticket identification 926 and an authentication ticket 927 are stored once the requesting user is allowed secured access.

The following examples illustrate the use of tables FIG. 1a to FIG. 1f.

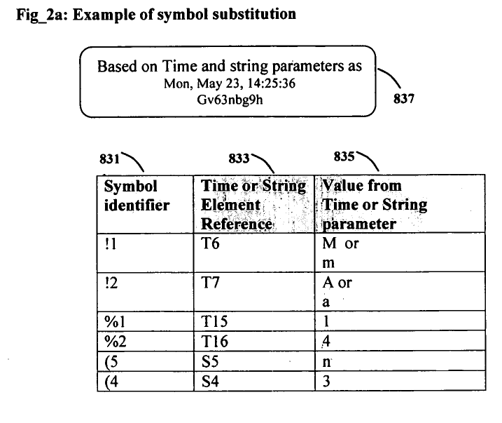

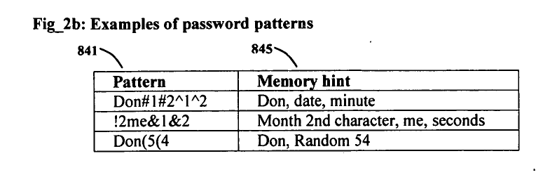

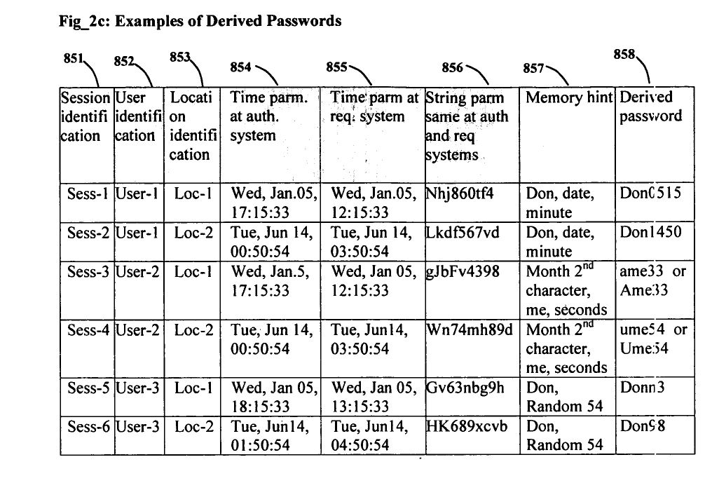

FIG. 2a Example of symbol substitution illustrates the symbol 831 and derivation of the value of the symbol 835. The symbol 831 is matched with the symbol identifier 811, and the corresponding position 815 is retrieved. The time element reference 871 and string element reference 875 is matched with 815. The time element value 873 or the string element value 877 against the matched element is the value of the symbol 835. The symbol identifiers 811 are unique and hence 831 can have either 873 or 877 has its unique value

FIG. 2b Examples of password patterns, show different constructs for PPW 841 and simple memory hints 845 associated with PPW to help users to memorize their PPW. The memory hint 845 is formulated by the user to assist in deriving the password. 845 is memorized by the user like memorization of conventional password. 845 is not stored in the system.

Validity checks for PPW:
A. PPW should contain only alpha characters, numeric digits and symbols in FIG. 1c.
B. Derived PW should contain only alpha characters and numeric digits.
C. The BPW and GPW are derived passwords and follow derived PW validation checks.
D. When the user changes PPW, if the changed string contains symbols from FIG. 1c, then the string represents a PPW, otherwise it is the conventional PW.
E. The authenticating system and the users substitute the symbols in PPW as illustrated in FIG. 2a, to derive BPW and GPW.

FIG. 2c Examples of Derived Passwords, show method of deriving BPW & GPW 858 for different session identifications 851, user identification 852, Location identification 853, time parameters at the authenticating system 854 and string parameters at authenticating system 856.

In sess-1,

the authenticating system when requesting system initiates a secured access request
A. calculates the time parameter at requesting system 855 from the value of the time parameter at the authenticating system 854 using the location identification 853 and the variance 825,
B. generates the unique session identification 851 and
C. generates the string parameter 856
D. stores them in string table 921, 923, 924, 925 and
E. sends them to the requesting system.

The user at the requesting system recalls the memory hint 845, derives the BPW 858 using the displayed 855 and 856 and submits the request for secured access. The actual symbols used by the system in PPW need not be memorized.

The authenticating system on receipt of the request for secured access constructs GPW by
A. retrieves the PPW 805 from FIG. 1d for the user identification in the request for secured access,
B. retrieves the 924 and 925 from FIG. 1f for the session identification in the request for secured access,
C. retrieves 815 from FIG. 1c for the embedded symbols in 805,
D. copies 924 and 925 to FIG. 1a and FIG. 1b and
E. substitutes values for 815 from 873 and 877.

The user identification and BPW combination is valid if the BPW and GPW matches.

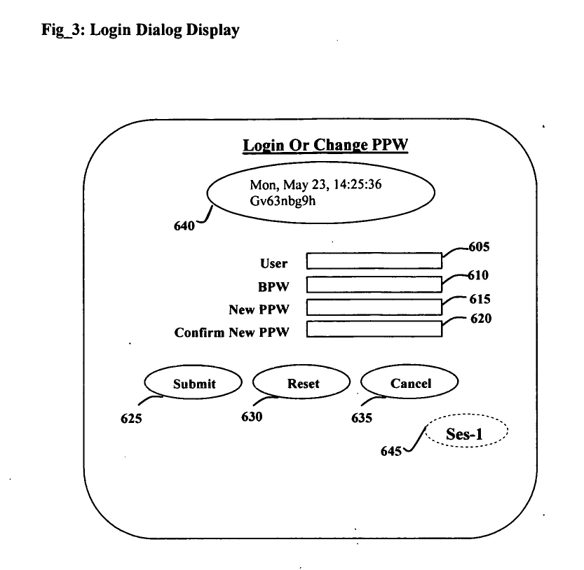

FIG. 3 the login dialog display, comprises of a display of the time parameter and the string parameter 640, entry boxes for the user identification 605, built password 610, new password pattern 615, confirm new password pattern 620, submit button 625, reset button 630, cancel button 635 and the hidden display of the session identification 645.

The Summary of Operations is:

A person responsible for the security and maintenance of the authenticating system sets up the tables FIG. 1a to FIG. 1f, adds location identifications, user identifications and informs the users of their temporary password pattern. Only users in the users table are authorized to access the secured resources.

Users initiate a login session. Authenticating system, returns a login dialog FIG. 3 with the session identification, the time and the string parameters

User login, using user identification 605, a BPW 610 derived from the displayed time and string parameters 640 and the user's PPW recalled from memory. The new PPW 615 and confirm new PPW 620 are entered when the user wishes to change the PPW.

The authenticating system creates GPW as described in FIG. 2c, compares GPW with BPW. If matched, issues an authentication ticket, otherwise denies access to the user.

The authentication ticket with the session identification is maintained by the authenticating system and responds to the secured resources requests for validation of authentication tickets.

### OPERATIONS OF THE PREFERRED EMBODIMENT

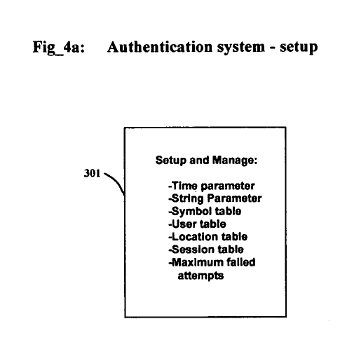

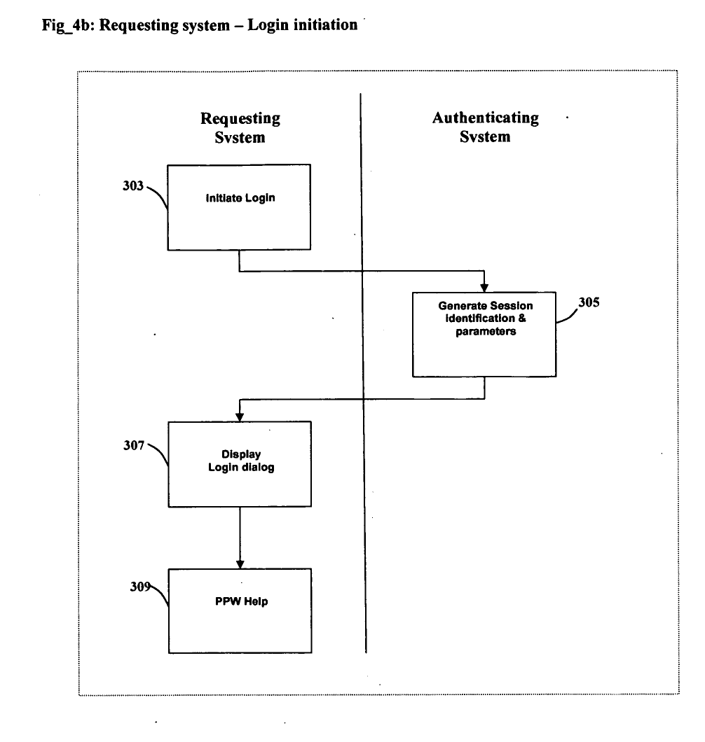

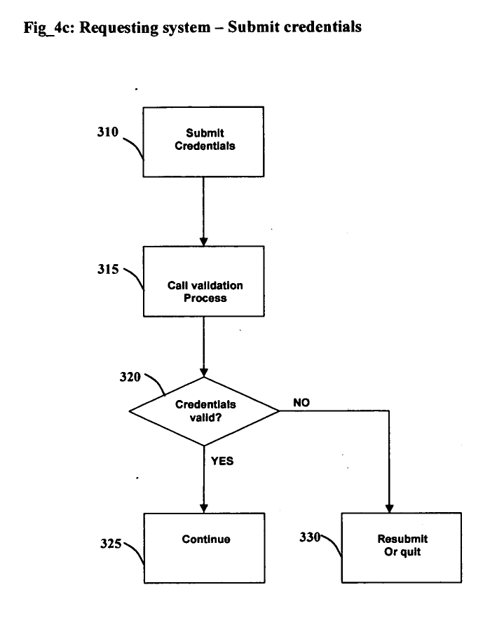

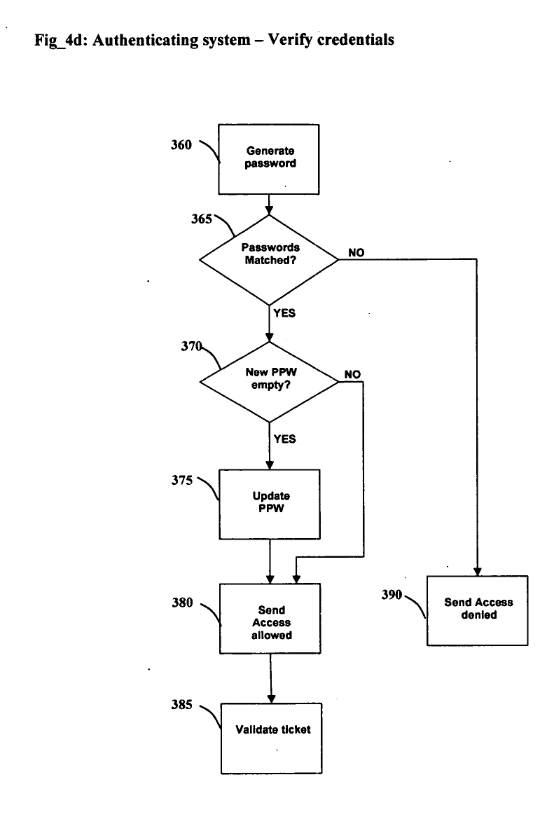

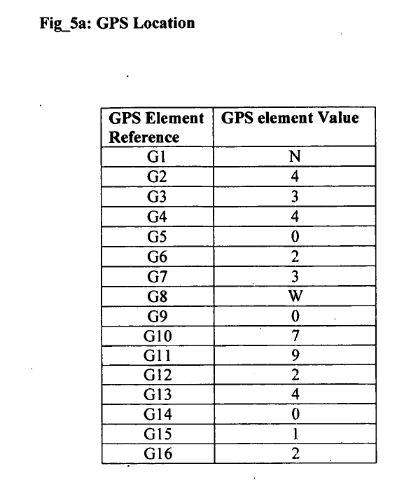

FIG. 4a a setup and manage method 301 illustrates the maintenance of the tables FIG. 1a to FIG. 1f:
A. Creates symbol table FIG. 1c and make it available to the users of the secured resources.
B. Creates a user table FIG. 1d, for new users, add user identification and temporary PPW to the user table FIG. 1d and inform the user,
C. Creates location table FIG. 1e and
D. Creates session table FIG. 1f.
E. Creates time parameter table FIG. 1a.
F. Creates string parameter table FIG. 1b and
G. Assign a count for maximum failed attempts

FIG. 4b Requesting system login initiation illustrates the initiation of the login session by a user from the requesting system.

Initiate login method 303 sends an initiate login request to the authenticating system by activating a button in a display screen or a switch on a device. The initiate request contains the requesting device location identification.

Generate session identification and parameters method 305 in the authenticating system creates the unique session identification 921, the session time parameter adjusted to the requesting system's location identification 924, the session string parameter 925 and stores them in the session table FIG. 1f. The Login dialog FIG. 3 with 921, 924 and 925 are sent to the requesting system.

Display the login dialog method 307 displays the login dialog FIG. 3 with the time and string parameters sent from 305. The session identification is hidden.

A help button method 309 provides instructions on the login process and the PPW.

FIG. 4c Requesting system—submit credentials illustrates the login process with the user credentials.

A submit credentials method 310, lets the user enter in the 307 login dialog the User identification 605, user's BPW 610 by substituting the current value of the parameter elements 640 for the embedded symbols in user's PPW recalled from user's memory. If the user wishes to change the PPW, a valid PPW is entered in the new PPW 615 and confirm PPW 620 entry boxes.

The present invention works on either conventional PW or invention's PPW, described as a PW Mode and a PPW Mode respectively. The transition between the modes is transparent to the user. By entering a valid PPW in 615 and 620, user starts using invention's PPW mode. Entering a valid conventional PW in 615 and 620, the user starts using conventional PW mode. Conventional PW entry boxes and validations do not accept symbols. As per this invention's requirement, 615 and 620 should accept symbols so that PPW can be entered. The requesting system and the authenticating system process both modes identically and there is no tracking of the password mode.

The user can clear the entry boxes by activating the reset button 630 or cancel out of the login session by activating the cancel button 635. After completing the entries, the user submits the entries to the validating system by activating the submit button 625. If the entries in the New PPW 615 and the Confirm PPW 620 are not identical an error message is shown and the user is allowed to correct the entries otherwise process continues with a 315 method to call validation.

The 315 Call validation method sends the entered data in 307 and the session identifier to the authenticating system FIG. 4d, which returns if credentials are valid an access allowed and an authentication ticket or if credentials are invalid an access denied message.

A credentials valid decision method 32p checks the returned message from the authenticating system FIG. 4d, which is either access allowed or access denied. If access allowed, the process continues with a continue method 325 otherwise the process is transferred to a resubmit or quit method 330.

The continue method 325, allows the user access secured resources using the authentication ticket or any of the currently used access control means after the credentials are successfully validated.

The resubmit or quit method 330, let the user correct entries and retry or quit the login operation.

FIG. 4d Authenticating system—verify credentials illustrate the authentication process.

A generate password method 360 sets on error if user identification, session identification and the symbols in the new PPW are not in the authentication tables. If these checks do not fail, the user's password pattern 805 is retrieved for the user identification in 315. The session time parameter 924 and the session string parameter 925 are retrieved for the session identification in 315. The values of the symbols embedded the PPW 805 are determined from the retrieved 924 and 925. The symbols are substituted by their determined values to derive the GPW.

Passwords matched method 365 compares the BPW in 315 with the GPW 360. If they are identical, the process continues with a new PPW empty method 370 otherwise the process is transferred to an access denied method 390.

The new PPW empty method 370 checks if the new PPW in 315 is empty. And, if empty, transfers the process to a access allowed method 380, otherwise continues the process with a update PPW method 375.

The update PPW method 375, updates the user table FIG. 1d, PPW field 805 with the new PPW in 315 for the user identification in 315.

The access allowed method 380 creates an authentication ticket, updates the session table with user identification in 315, location identification in 315 and the created authentication ticket for the session identification 315. The authentication ticket and an access allowed message are returned to 315 of the requesting system. The authentication ticket is to illustrate the successful completion of authentication. Any of the currently used access control to the secured resources, after the user credentials has been established, can be used.

A validate ticket method 385 responds to challenges from secured resources checking on authentication tickets submitted to the secured resources. If the authentication ticket is valid and active in the session table FIG. 1f, a ticket valid message is sent to the secured resource otherwise the secured resource forces the requesting system to login.

The access denied method 390 sends an access denied to the requesting system 315, and the number of failures against the session identification 928 is maintained. If the number of failed attempts exceeds a preset number of maximum failed attempts FIG. 4a(g), the login initiation FIG. 4b is forced. This will force the user to derive the BPW using a new set of parameters.

### Alternate Embodiments

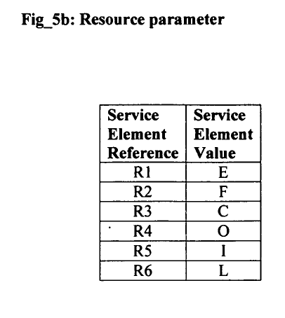

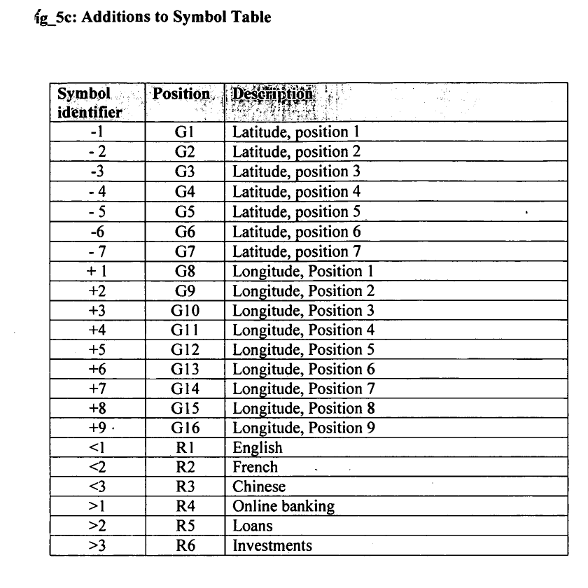

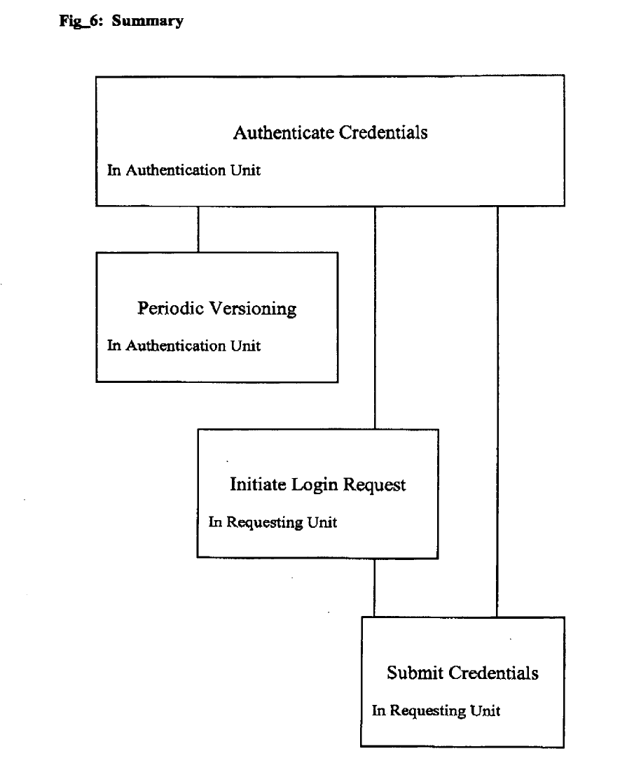

A. FIG. 5a illustrates an alternate GPS method. The set of parameters can consist of one or more parameters and need not include FIG. 1a and FIG. 1b. In mobile and wireless applications, the GPS location can be used as the location identification to initiate login FIG. 4b 303. The GPS location can then be used to create one of the parameter set FIG. 5a. The requesting system displays its location on the login display FIG. 3 640 and does not depend on the authenticating system to send the parameter set. The user's memory hint for example can be latitude last 3 digits followed by XYZ. Once the login is successful, the messages that follow can be associated with the authentication ticket and the GPS location to ensure that the communication is with the authorized mobile and wireless user at the GPS location.
B. FIG. 5b illustrates an alternate menu method. In another alternate embodiment, the parameter elements can refer to programs that have additional intelligence on secured resource. FIG. 5b illustrates user selecting the service as they login. The elements referring to programs are not used to compare BPW and GPW, FIG. 4d 360 and 365, but used as menu selection from available secured resources. Thus, the user can skip some menu selection steps and secure the specific resource faster if the user is authorized to use the specific resource. The menu selection can be embedded in the authentication ticket and the selected resource can test for user's permissions. The user decides on including the menu selection facility through the password pattern
C. FIG. 5c Additions to the Symbol table, illustrates the additional symbols needed to incorporate the GPS and Menu facilities.

### CONCLUSION, RAMIFICATION AND SCOPE OF INVENTION

Accordingly, the reader will see that protection of password through patterns invention secures the password by making the user to derive the password at the time of requesting authentication. The formula for deriving the password is known only to the user. The password as a string is worthless after the login session, they have to be derived each time using the changing parameter values. The password pattern technique can be used by authorized persons and devices. It is simple to use and does not require any special equipment. The present invention can be used over the Internet, by ATM machines and smart cards without fear of snooping and sniffing devices and programs that scans for password through iterative attempts.

In ATM machines, the secured resources are the financial service systems and parts of the inventions authenticating system are on the smart card. The financial service systems will challenge the smart card for the authentication component the smart card issued. The smart card inserted in to the ATM machine has to respond. This ensures that the transaction has a valid smart card and an authorized user. Not a virtual card over the net. In the case of transactions over the Internet, the user should know the password pattern to get authenticated.

The ability to determine the password through repeated attempts is eliminated since the set of parameters will be changed after the number of failed attempts exceeds the preset number of tries. This will force the iteration algorithm to start all over again.

On mobile and wireless applications, only the authenticated user at the requesting location can activate the secured service. Listeners at different location can not gain access.

The user can make the password pattern more efficient by making the derived test for access permission for specific resource. The resource selection is not decipherable by snooping devices and listeners.

While my above description contains much specificity, these should not be construed as limitations on the scope of the invention, but rather as an exemplification of one preferred embodiment thereof. Many other variations are possible. For example, the random string could be in multiple parts or the parameters for the symbol could be based on last successful transaction attributes that can easily remembered by the authorized user, device and the authentication system. In the process sequences, alterations could be made to achieve the same result.

Accordingly, the scope of the invention should be determined not by the embodiments illustrated, but by the appended claims and their legal equivalents.

I claim:

1. A method for protecting passwords of a plurality of authorized users accessing secured resources comprising of an authenticating system having means to store and manage a plurality of password patterns, a plurality of parameters used in deriving passwords from the said password patterns and a plurality of requesting systems using the said derived password to gain access to secured resources, the said password patterns having the intelligence and unique feature of automatically changing the said derived passwords by changing the said parameters

2. the said authenticating system of claim 1, further comprising of a setup means to create and manage a memory to store a time parameter, one of the set of parameters of 1, having a plurality of time elements,
a memory to store a string parameter, one of the set of parameters of claim 11 comprising further of a string of random characters and digits having a plurality of string elements,
a memory to store a GPS parameter, one of the set of parameters of claim 1, having a plurality of time elements,
a memory to store a menu parameter, one of the set of parameters of claim 1, having a plurality of time elements,
a memory to store a symbol table comprising of a plurality of a symbol identifier and the position of the said time elements or the position of the said string elements the symbol identifier represents,
a memory to store a user table comprising of a plurality of a user identification and a plurality of the said password pattern of claim 1 each member of the plurality of the said user identification having an associated said password pattern of claim 1,
a means to assign a temporary password pattern to new users and those who have forgotten their password pattern and updating the said user table with the said user identification and the said temporary password pattern as the user's said password pattern,
a memory to store a location table comprising of a plurality of a location identification of devices that are capable of requesting secured access and a plurality of a variance, each member of the plurality of the said location identification having an associated said variance,
a memory to store a session table comprising of a plurality of a session identifications each member comprising of a session time parameter, a session string parameter, a session user identification, a session location identification, an authentication ticket identification, an authentication ticket and a failed attempts counter,
a memory to store maximum failed counter,
a login dialog box comprising of
a display box to show the said time parameter,
a display box to show the said session parameter
an entry box for entering a login user identification,
an entry box for entering a built password,
an entry box for entering a new password pattern,
an entry box for entering a confirm new pattern,
a submit button to submit the contents of the entry boxes to the said authenticating system of claim 1
a reset button to clear the contents of the entry boxes,
a cancel button to exit from the said login session and
a hidden display box containing the said session identification of claim 2;

3. the requesting system of claim 1, further comprising of:
a login session that manages all communications between the said requesting system of claim 1 and the said authenticating system of claim 1 from the time a request for secured access is initiated to the time the secured access is allowed or denied,
an initiate login means to commence the login session using the said location identification,

4. the authenticating system of claim 1 further comprising of
a generate session identification and parameters means to
(a) identify the login session of claim 3 with a unique said session identification of claim 2,
(b) generate the said time parameter denoting date and time or any attribute of an event that is assigned to the said time parameter of claim 2;
(c) generate the said string parameter of claim 2,
(d) update the said session table of claim 2 with the created session identification (a), the session time parameter (b) and the session string parameter (c).
(e) respond to the initiate login means of claim 3 by returning the login session dialog of claim 2 with the login session identification as (a), a session time parameter as (b) and the session string parameter as (c),

5. the requesting system of claim 3 further comprising of the display login dialog means to allow user to enter data on the login session dialog of claim 4(e), where (b) and (c) are displayed and (a) is hidden, with:
(f) the said login user identification of claim 2,
(g) the said built password of claim 2 with the string derived by the user from the password pattern's memory hint (h) recalled by the user from memory, substituting the symbol identifiers with the corresponding values displayed in the said login time parameter (b) and the said session parameter (c),
(h) and if the user wishes to change the said user's password pattern, enter the new password pattern and memorize the new password pattern through a memory hint,
(i) and enter the confirm the new password pattern, and force the user to reenter claim 5(h) and claim 5(i) if they do not match,

6. the requesting system of claim 3 further comprising of a password pattern help means to display instructions and notes on the password pattern,

7. the requesting system of claim 1 further comprising of a submit credentials means to verify the data entered on to the said login session dialog of claim 5,

8. the requesting system of claim 1 further comprising of
a call validation process means to send the entered data of the said login session dialog of claim 5 to the authenticating system of claim 1;

9. the authenticating system of claim 1 further comprising of
a generate password means to
(j) retrieving the session time parameter, from the session table of claim 2 for the session identification of claim 5,
(k) retrieving the session string parameter, from the session table of claim 2 for the session identification of claim 5,
(l) retrieving the password pattern from the user table of claim 2 for the login user identification of claim 5,
(m) substituting the symbol identifiers in (k) by corresponding characters and digits in the (i) and (j) using the positions denoted by the symbol table of claim 2,

10. the authenticating system of claim 1 further comprising of
a password matched means that compares the generated password of claim 10(l) against the built password of claim 5(f) and returning the result,
(n) if comparison matched, as valid password,
(o) otherwise as invalid password,

11. the authenticating system of claim 1 further comprising of
an access denied means to return to the requesting system of claim 5, if the comparison result of claim 10 is (o) then
(p) an access denied message,
(q) update a counter of failed attempts counter of claim 2 for the session identification of claim 5
(r) if the said failed attempts counter (q) exceeds the said maximum failed attempts allowed counter of claim 2, then regenerate the said session identification, time and string parameters of claim 2,

12. the authenticating system of claim 1 further comprising of
a new password pattern empty means which, if the comparison result from claim 10 is (n) and the new password pattern returned of claim 5(h) is empty, returns the result that claim 5(h)
(s) is empty,
(t) otherwise is not empty,

13. the authenticating system of claim 1 further comprising of
an update password pattern means, if claim 12 result is (s), to update the said user table of claim 2, changing the said password pattern of claim 2 for the login user identification of claim 5(f) to the new password pattern of claim 5(h),

14. the authenticating system of claim 1 further comprising of
an access allowed means which if the claim 12 returned result is (t) or the claim 13 has successfully updated the user table of claim 2
(u) generates an authentication ticket,
(v) updates the session table of claim 2 with the login user identification of claim 5(f) and the generated authentication ticket (u) identification for the session identification of claim 5,
(w) returns an access allowed message and
(x) the said authentication ticket to the requesting system,

15. the requesting system of claim 1 further comprising of
a credentials valid means, if the returned message from the said authenticating system is access denied of claim 11(p) then returns result
(y) access invalid
(z) otherwise access valid

16. the requesting system of claim 1 further comprising of
a resubmit means, if the returned result from claim 15 is (y), the login dialog box of claim 5 is refreshed and displayed allowing the user to reenter the login dialog box and resubmit,

17. the refreshed dialog box of claim 16 further comprising of
previous attempts said claim 4 (a), (b) and (c) or
regenerated claim 4 (a), (b) and (c) by claim 1 (r),

18. the requesting system of claim 1 further comprising of
a continue means, if the returned result from claim 14 is (w) the requesting system of claim 8 accesses the secured resources using the authentication ticket (x) or current access control means that are used after successful completion of credential validation,

19. the authenticating system of claim 1 further comprising of
a validate ticket means to validate the said authentication ticket (x) when secured resources challenge the validity of the said authentication ticket (x)
whereby
i. the said derived password as a string is worthless after the login session, they have to be derived each time using the changing parameter values,
ii. the said password pattern can be used by authorized persons and devices and does not require any special devices,
iii. the said password pattern can be used over the Internet, by ATM machines and smart cards without fear of snooping and sniffing devices and programs that scans for password through iterative attempts,
iv. in the smart card applications, where part of the said authenticating system components are on the smart card, refresh of the said time and string parameters ensures the transactions are conducted by a valid smart card and user,
v. In mobile applications, authenticated users at the requesting location can activate secured services and
vi. Users can improve their efficiency of operation by including menu options in their password pattern.
